(19) United States
(12) Patent Application Publication
(10) Pub. No.: US 2010/0095207 A1
(43) Pub. Date: Apr. 15, 2010

(54) Method and System for Seamlessly Integrated Navigation of Applications

(76) Inventor: Pierre Bonnat, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 12/579,765

(22) Filed: Oct. 15, 2009

Related U.S. Application Data
(60) Provisional application No. 61/105,549, filed on Oct. 15, 2008.

(51) Int. Cl. G06F 3/01; G06F 3/048

(52) U.S. Cl. 715/702; 715/764

(57) ABSTRACT

Aspects of a system and method for seamlessly integrated navigation of applications are provided. A communication device comprising a display enabled to display media content may be operable to receive a first stimulus in a pre-defined section of the display. The communication device may be operable to display a semi-transparent interaction grid that is superimposed onto the content based on the received first stimulus. The communication device may enable one or more applications in the displayed semi-transparent interaction grid based on one or more received stimuli.

### CROSS-REFERENCE TO RELATED APPLICATIONS/INCORPORATION BY REFERENCE

This application makes reference to, claims priority to, and claims benefit of U.S. Provisional Application Ser. No. 61/105,549, filed Oct. 15, 2008.

The above stated application is incorporated herein by reference in its entirety.

### FIELD OF THE INVENTION

Certain embodiments of the invention relate to communication interfaces. More specifically, certain embodiments of the invention relate to a system and method for seamlessly integrated navigation of applications.

### BACKGROUND OF THE INVENTION

Communication devices generally provide an interface that enables one or more users to interact with the communication device. Exemplary interfaces may comprise a keyboard, a mouse, software keys or buttons (softkeys), hardware keys or buttons (hardkeys), touchscreen, gesture tracking devices, voice input/output, text to speech (TTS), and a visual and/or audio display.

Most existing mobile Graphical User Interfaces (GUIs) may implement a legacy from what was developed for personal computers, based on icons and menus. Furthermore, due to the mobile platform display's palm size and processing power, multi-windowing may not be available, or may be available only in restricted ways, and juggling between applications may be tedious.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for seamlessly integrated navigation of applications, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary communication interface illustrating organization of applications that may be utilized in connection with an embodiment of the invention.

FIG. 1B is a block diagram of another exemplary communication interface illustrating organization of applications that may be utilized in connection with an embodiment of the invention.

FIG. 1C is a block diagram of another exemplary communication interface illustrating organization of applications that may be utilized in connection with an embodiment of the invention.

FIG. 2 is a block diagram of an exemplary communication interface for seamlessly integrated navigation of applications, in accordance with an embodiment of the invention.

FIG. 3A is a diagram illustrating exemplary user interaction and navigation of applications, in accordance with an embodiment of the invention.

FIG. 3B is a diagram illustrating exemplary user interaction and navigation of applications, in accordance with an embodiment of the invention.

FIG. 3C is a diagram illustrating exemplary user interaction and navigation of applications, in accordance with an embodiment of the invention.

FIG. 3D is a diagram illustrating exemplary user interaction and navigation of applications, in accordance with an embodiment of the invention.

FIG. 4 is a flowchart illustrating exemplary steps for determining a type of received stimulus, in accordance with an embodiment of the invention.

FIG. 5 is a flowchart illustrating exemplary steps for seamlessly integrated navigation of applications, in accordance with an embodiment of the invention.

### DETAILED DESCRIPTION OF THE INVENTION

Certain embodiments of the invention may be found in a system and method for seamlessly integrated navigation of applications. In various embodiments of the invention, a communication device comprising a display, which is enabled to display media content, may be operable to receive one or more stimuli in a pre-defined section of the display. The communication device may be operable to display a semi-transparent interaction grid that is superimposed onto the content based on the received one or more stimuli. The communication device may be operable to enable one or more applications in the displayed semi-transparent interaction grid based on the received one or more stimuli. Notwithstanding, the invention may not be so limited and the interaction grid that is superimposed onto the content may be outlined or materialized with a symbol without limiting the scope of the embodiment.

In accordance with an embodiment of the invention, a graphical user interface (GUI) is provided that is operable to provide enhanced user interaction experience. The GUI may be operable to merge different technologies and/or merge content provided by different technologies such that elements from the different technologies and/or content mixes and overlays with one another. In this regard, the GUI may be operable to deliver and combine optimized visualization of content, decreased density, an uncluttered interface, real time access to content and applications, and reduced “click distance.” The GUI may also be operable to provide better and direct interaction, greater flexibility and augmented knowledge of users' content via interface customization. The GUI may be operable to provide intuitive interactive connection of files, applications, features, and settings, for example, which maintains content integrity throughout mobile user experience, and is tailored to digital mobile lifestyles.

In various embodiments of the invention, the GUI may be operable to function independent of a service provider that may provide or offer services that are accessible via the communication device. In this regard, for example, the GUI may be presented on a wireless communication device such as a mobile terminal and the GUI may operate independent of any wireless carrier that provides service or services to the wireless communication device.

Various exemplary embodiments of the invention may provide maximized content exposure, simplified and accelerated navigation, optimized access to real time information, organized and logical interaction with various applications. For example, in one embodiment of the invention, there may be no “Home Screen” where users may need to return every time to access other applications, and navigation tools may pop up on top of any screen, any form of content, and with a minimized visual footprint that may be superimposed in a non obtrusive, dynamic, semi-transparent manner, outlined or materialized with a symbol onto the content.

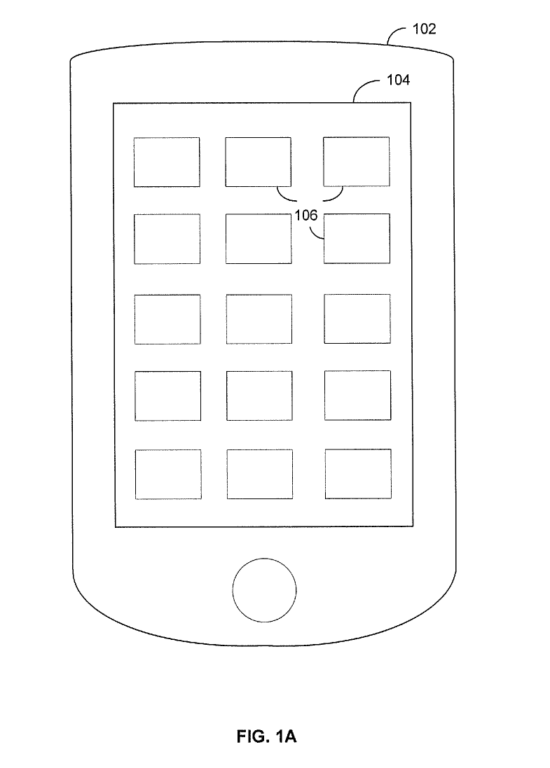

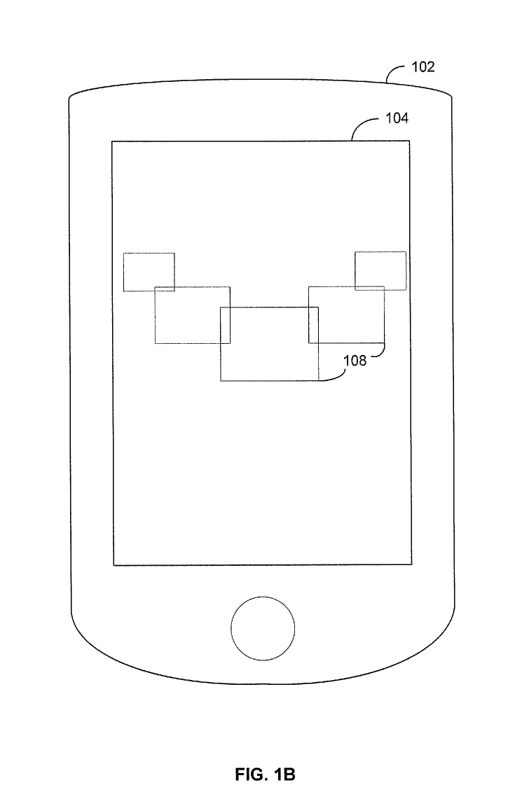

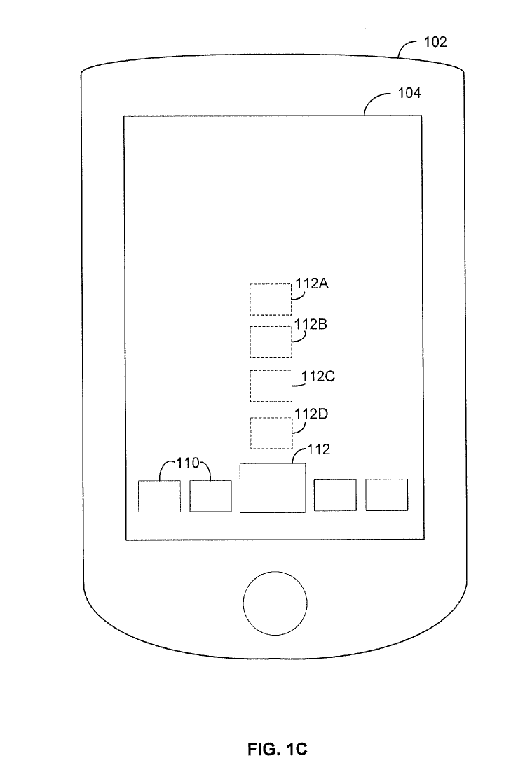

FIG. 1A is a block diagram of an exemplary communication interface illustrating organization of applications that may be utilized in connection with an embodiment of the invention. Referring to FIG. 1A, there is shown a communication device 102. The communication device 102 may comprise a display 104. The display 104 may be a touch-screen display or a non-touch-screen display. The display 104 may comprise suitable logic, circuitry, interfaces and/or code that may be operable to display content or one or more applications 106. Each of the one or more applications 106 may be enabled to perform one or more functions. For example, a “News” application may be enabled to display current news headlines from one or more news agencies. However, the communication device 102 may require a user to return to a “home screen” every time to access any particular application 106. The communication device 102 may not allow a user to display content while navigating one or more applications 106.

FIG. 1B is a block diagram of another exemplary communication interface illustrating organization of applications that may be utilized in connection with an embodiment of the invention. Referring to FIG. 1B, there is shown a communication device 102. The communication device 102 may comprise a display 104. The display 104 may be a touch-screen display or a non-touch-screen display. The display 104 may comprise suitable logic, circuitry, interfaces and/or code that may be operable to display content or one or more applications 108. Each of the one or more applications 108 may be enabled to perform one or more functions. For example, a “Weather” application may be enabled to display current weather at a selected location. The one or more applications 108 may be visually scrollable, and a user may select one of the applications 108 from the list of applications 108. However, the communication device 102 may require a user to return to a “home screen” every time to access any particular application 108. The communication device 102 may not allow a user to display content while navigating one or more applications 108.

FIG. 1C is a block diagram of another exemplary communication interface illustrating organization of applications that may be utilized in connection with an embodiment of the invention. Referring to FIG. 1C, there is shown a communication device 102. The communication device 102 may comprise a display 104. The display 104 may be a touch-screen display or a non-touch-screen display. The display 104 may comprise suitable logic, circuitry, interfaces and/or code that may be operable to display content or one or more applications 110 and 112. Each of the one or more applications 110 and 112 may be enabled to perform one or more functions. For example, a “Calculator” application may be enabled to display a calculator to perform arithmetic operations. Similarly, a “Contacts” application may be enabled to display a list of user contacts along with their contact information. The one or more applications 110 and 112 may be horizontally scrollable, and a user may select one of the applications, for example, 112 from the list of applications 110 and 112. Upon selecting a particular application 112, one or more sub-applications 112A, 112B, 112C and 112D may pop up. For example, upon clicking a “Contacts” application 112, a list of contacts or sub-applications 112A, 112B, 112C and 112D may pop up that may display the list of user contacts along with their contact information. However, the communication device 102 may require a user to return to a “home screen” every time to access any particular application 110 or 112. The communication device 102 may not allow a user to display content while navigating one or more applications 110 and 112.

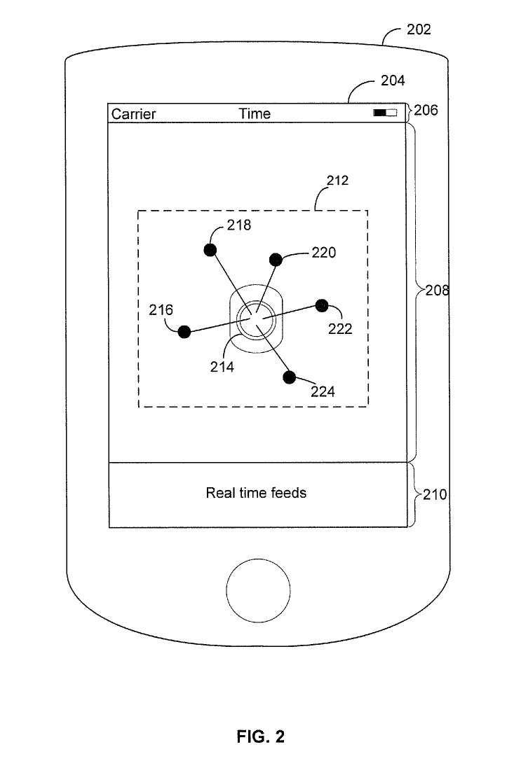

FIG. 2 is a block diagram of an exemplary communication interface for seamlessly integrated navigation of applications, in accordance with an embodiment of the invention. Referring to FIG. 2, there is shown a communication device 202. The communication device 202 may comprise a display 204. The display 204 may be a touch-screen display or a non-touch-screen display. The display 204 may comprise suitable logic, circuitry, interfaces and/or code that may be operable to display content or one or more applications.

The display 204 may be divided into one or more sections, for example, section 206, section 208, and section 210. Notwithstanding, the invention may not be so limited and the display 204 may be divided into more or less than three sections without limiting the scope of the embodiment.

The communication device 202 may comprise suitable logic, circuitry, interfaces and/or code that may be operable to display vital and functional data in section 206 of the display 204. For example, in one embodiment of the invention, the section 206 of the display 204 may display the current date, time, carrier, strength of the carrier signal, new messages, and/or a battery indicator. The section 206 of the display 204 may be user customizable, for example, and may be adjusted to display other information. In one embodiment, no user interaction may be allowed to customize the section 206 of the display 204 and may be preset by a phone manufacturer, for example.

The communication device 202 may comprise suitable logic, circuitry, interfaces and/or code that may be operable to display real time feeds and updates in the section 210 of the display 204. For example, in one embodiment of the invention, the section 210 of the display 204 may display real time feeds from one or more news agencies or blogs. The section 210 of the display 204 may be user customizable, for example, and may be adjusted to display other information. In one embodiment of the invention, the communication device 202 may enable a user to interact by receiving a stimulus. The received stimulus may enable selection of a particular real time feed to further access the corresponding real time content, for example. In another embodiment of the invention, the communication device 202 may enable periodic updating of the real time feeds displayed in the section 210 of the display 204.

The communication device 202 may comprise suitable logic, circuitry, interfaces and/or code that may be operable to display content and/or applications in the section 208 of the display 204. In one embodiment of the invention, the section 208 may be pre-defined to display content and enable user interaction with the communication device 202. Notwithstanding, other sections or zones in the display 204 may be pre-defined to enable user interaction with the communication device 202 without limiting the scope of the invention.

The communication device 202 may be operable to receive one or more stimuli 214 in the pre-defined section 208 of the display 204. The received one or more stimuli 214 may comprise one or more of a single touch stimulus, a multi-touch stimulus, an infrared stimulus, an ultrasonic stimulus, a keyed input stimulus, and/or a speech-based stimulus.

In accordance with an embodiment of the invention, when a user applies a single touch stimulus 214 onto the surface of the display 204, the communication device 202 may be operable to determine whether a duration of the received single touch stimulus 214 is above a particular time threshold T. The communication device 202 may be operable to determine whether motion of the single touch stimulus 214 over the display 204 is above a particular pixel threshold P. If the duration of the single touch stimulus 214 is above a particular time threshold T, and the motion of the single touch stimulus 214 over the display 204 is above a particular pixel threshold P, the communication device 202 may be operable to display a semi-transparent interaction grid 212 that is superimposed onto the content based on the received single touch stimulus 214. In accordance with another embodiment of the invention, if the duration of the single touch stimulus 214 is above a particular time threshold T, and the motion of the single touch stimulus 214 over the display 204 is above a particular pixel threshold P, the communication device 202 may be operable to display an outlined interaction grid 212 or an interaction grid 212 materialized with a symbol that is superimposed onto the content based on the received single touch stimulus 214

In accordance with another embodiment of the invention, the transparency level, outlining and/or the symbol of the interaction grid 212 may be customizable by a user. Notwithstanding, the invention may not be so limited and other stimuli, such as a multi-touch stimulus, an infrared stimulus, an ultrasonic stimulus, a keyed input stimulus, and/or a speech-based stimulus may be received by the communication device 202 without limiting the scope of the invention.

The semi-transparent interaction grid 212 may comprise one or more of the categories 216, 218, 220, 222 and 224. Each of the plurality of categories may comprise one or more sub-categories and/or applications. Each of the one or more categories, sub-categories and/or applications may be organized logically and/or modified based on user preferences. For example, the semi-transparent interaction grid 212 may comprise one or more of categories such as “Communication”, “Entertainment”, “Internet”, “Utilities” and “Settings”. The “communication” category may comprise one or more sub-categories, for example, “Contacts” and one or more applications, for example, “Voice mail”, “Text messages” and “Keypad”. The sub-category “Contacts” may comprise one or more sub-categories, for example, “Friends contacts list” and “Work contacts list”. Each of the sub-categories “Friends contacts list” and “Work contacts list” may comprise one or more applications listing contacts and their corresponding contact information.

The “Entertainment” category may comprise one or more sub-categories, for example, “Music player”, “Games”, and “Videos” and one or more applications, for example, “Camera”. The sub-category “Music player” may comprise one or more applications, for example, “Playlist 1” and “Playlist 2”. The sub-category “Games” may comprise one or more applications, for example, “Game 1” and “Game 2”. The sub-category “Videos” may comprise one or more applications, for example, “Video 1”, “Video 2” and “Video 3”.

The “Internet” category may comprise one or more sub-categories, for example, “Favorites” and one or more applications, for example, “Web Browser”, and “Stocks”. The sub-category “Favorites” may comprise one or more applications, for example, “Favorites 1” and “Favorites 2”.

The “Utilities” category may comprise one or more applications, for example, “GPS”, “Weather”, “Time”, and “Calendar”. The “Settings” category may comprise one or more applications, for example, “Phone Settings” and “Multimedia Settings”.

The communication device 202 may be operable to enable one or more applications, for example, the “Weather” application in the semi-transparent interaction grid 212 based on the received single touch stimulus 214 on the selected application, for example, the “Weather” application.

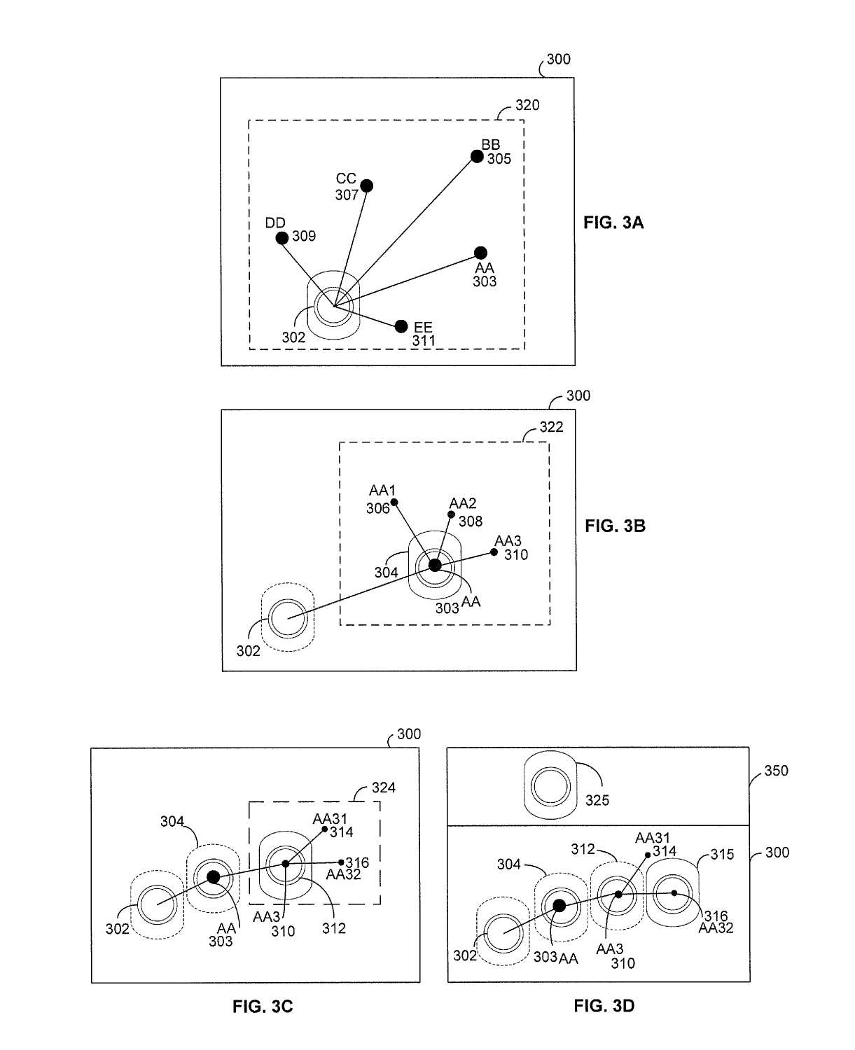

FIG. 3A is a diagram illustrating exemplary user interaction and navigation of applications, in accordance with an embodiment of the invention. Referring to FIG. 3A, there is shown a section 300 of a display 204. The section 300 may be operable to display content and/or applications. In one embodiment of the invention, the section 300 may be pre-defined to display content and enable user interaction with the communication device 202. The communication device 202 may be operable to receive one or more stimuli 302 in the pre-defined section 300. The received one or more stimuli 302 may comprise one or more of a single touch stimulus, a multi-touch stimulus, an infrared stimulus, an ultrasonic stimulus, a keyed input stimulus, and/or a speech-based stimulus.

In accordance with an embodiment of the invention, when a user applies a single touch stimulus 302 onto the surface of the display 204, the communication device 202 may be operable to display an upper level of the semi-transparent interaction grid 320 based on the received one or more stimuli 302. The upper level of the semi-transparent interaction grid 320 may comprise an upper set of categories AA 303 and BB 305, sub-categories CC 307 and DD 309 and/or applications EE 311.

FIG. 3B is a diagram illustrating exemplary user interaction and navigation of applications, in accordance with an embodiment of the invention. Referring to FIG. 3B, there is shown a section 300 of a display 204. The section 300 may be operable to display content and/or applications. In one embodiment of the invention, the section 300 may be pre-defined to display content and enable user interaction with the communication device 202. The communication device 202 may be operable to receive one or more stimuli 302 and 303 in the pre-defined section 300. The received one or more stimuli 302 and 303 may comprise one or more of a single touch stimulus, a multi-touch stimulus, an infrared stimulus, an ultrasonic stimulus, a keyed input stimulus, and/or a speech-based stimulus.

In accordance with an embodiment of the invention, when a user applies a single touch stimulus 302 onto the surface of the display 204, the communication device 202 may be operable to display an upper level of the semi-transparent interaction grid 320 based on the received one or more stimuli 302. The upper level of the semi-transparent interaction grid 320 may comprise an upper set of categories AA 303 and BB 305, sub-categories CC 307 and DD 309 and/or applications EE 311.

When a user applies a single touch stimulus 304 onto the surface of the display 204, the communication device 202 may be operable to display a lower level of the semi-transparent interaction grid 322 based on the received one or more stimuli 304. The lower level of the semi-transparent interaction grid 322 may comprise a lower set of sub-categories AA1 306 and AA3 310, and/or applications AA2 308. In accordance with an embodiment of the invention, the communication device 202 may be operable to exit a portion of the displayed upper level of the semi-transparent interaction grid 320 based on the received one or more stimuli 304.

FIG. 3C is a diagram illustrating exemplary user interaction and navigation of applications, in accordance with an embodiment of the invention. Referring to FIG. 3C, there is shown a section 300 of a display 204. The section 300 may be operable to display content and/or applications. In one embodiment of the invention, the section 300 may be pre-defined to display content and enable user interaction with the communication device 202. The communication device 202 may be operable to receive one or more stimuli 302, 303 and 312 in the pre-defined section 300. The received one or more stimuli 302, 303 and 312 may comprise one or more of a single touch stimulus, a multi-touch stimulus, an infrared stimulus, an ultrasonic stimulus, a keyed input stimulus, and/or a speech-based stimulus.

In accordance with an embodiment of the invention, when a user applies a single touch stimulus 302 onto the surface of the display 204, the communication device 202 may be operable to display an upper level of the semi-transparent interaction grid 320 based on the received one or more stimuli 302. The upper level of the semi-transparent interaction grid 320 may comprise an upper set of categories AA 303 and BB 305, sub-categories CC 307 and DD 309 and/or applications EE 311.

When a user applies a single touch stimulus 304 onto the surface of the display 204, the communication device 202 may be operable to display a lower level of the semi-transparent interaction grid 322 based on the received one or more stimuli 304. The lower level of the semi-transparent interaction grid 322 may comprise a lower set of sub-categories AA1 306 and AA3 310, and/or applications AA2 308.

When a user applies a single touch stimulus 312 onto the surface of the display 204, the communication device 202 may be operable to display a lower level of the semi-transparent interaction grid 324 based on the received one or more stimuli 312. The lower level of the semi-transparent interaction grid 324 may comprise a lower set of applications AA31 314 and AA32 316. In accordance with an embodiment of the invention, the communication device 202 may be operable to exit a portion of the displayed upper level of the semi-transparent interaction grid 320 and the displayed lower level of the semi-transparent interaction grid 322 based on the received one or more stimuli 312.

FIG. 3D is a diagram illustrating exemplary user interaction and navigation of applications, in accordance with an embodiment of the invention. Referring to FIG. 3D, there is shown a section 300 of a display 204. The section 300 may be operable to display content and/or applications. In one embodiment of the invention, the section 300 may be pre-defined to display content and enable user interaction with the communication device 202. The communication device 202 may be operable to receive one or more stimuli 302, 303, 312 and 315 in the pre-defined section 300. The received one or more stimuli 302, 303, 312 and 315 may comprise one or more of a single touch stimulus, a multi-touch stimulus, an infrared stimulus, an ultrasonic stimulus, a keyed input stimulus, and/or a speech-based stimulus.

In accordance with an embodiment of the invention, when a user applies a single touch stimulus 302 onto the surface of the display 204, the communication device 202 may be operable to display an upper level of the semi-transparent interaction grid 320 based on the received one or more stimuli 302. The upper level of the semi-transparent interaction grid 320 may comprise an upper set of categories AA 303 and BB 305, sub-categories CC 307 and DD 309 and/or applications EE 311.

When a user applies a single touch stimulus 304 onto the surface of the display 204, the communication device 202 may be operable to display a lower level of the semi-transparent interaction grid 322 based on the received one or more stimuli 304. The lower level of the semi-transparent interaction grid 322 may comprise a lower set of sub-categories AA1 306 and AA3 310, and/or applications AA2 308.

When a user applies a single touch stimulus 312 onto the surface of the display 204, the communication device 202 may be operable to display a lower level of the semi-transparent interaction grid 324 based on the received one or more stimuli 312. The lower level of the semi-transparent interaction grid 324 may comprise a lower set of applications AA31 314 and AA32 316.

The communication device 202 may be operable to enable one or more applications AA32 316 in the displayed lower level of the semi-transparent interaction grid 324 based on the received one or more stimuli 315. In accordance with an embodiment of the invention, the communication device 202 may be operable to exit a portion of the displayed upper level of the semi-transparent interaction grid 320 and the displayed lower level of the semi-transparent interaction grid 322 based on the received one or more stimuli 315. In accordance with another embodiment of the invention, the communication device 202 may be operable to exit the displayed semi-transparent interaction grid 212 based on the received one or more stimuli 325. The received one or more stimuli 325 may be in section 350 that is outside the pre-defined section 300 of the display 204. For example, in accordance with an embodiment of the invention, if a stimulus 325 is received in section 350, the communication device 202 may be operable to exit the displayed semi-transparent interaction grid. For example, in accordance with another embodiment of the invention, if a stimulus 325 is received in the pre-defined section 300 to enable previously displayed content, the communication device 202 may be operable to exit the displayed semi-transparent interaction grid 212 and enable the previously displayed content.

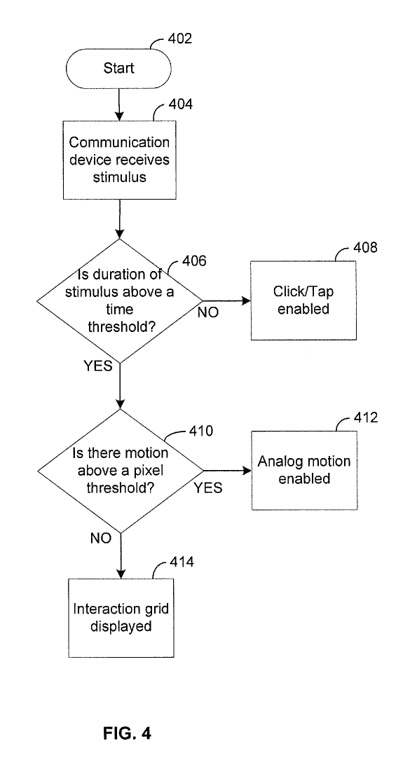

FIG. 4 is a flowchart illustrating exemplary steps for determining a type of received stimulus, in accordance with an embodiment of the invention. Referring to FIG. 4, exemplary steps may begin at step 402. In step 404, the communication device 202 may be operable to receive a stimulus, for example, a single touch stimulus 302. In step 406, it may be determined whether a duration of the received stimulus 302 is above a particular time threshold T. In instances where the duration of the received stimulus 302 is not above a particular time threshold T, control passes to step 408. In step 408, a “click” or “tap” functionality may be enabled. In instances where the duration of the received stimulus 302 is above a particular time threshold T, control passes to step 410.

In step 410, it may be determined whether a motion of the received stimulus 302 is above a particular pixel threshold P. In instances where the motion of the received stimulus 302 is above a particular pixel threshold P, control passes to step 412. In step 412, an “analog” motion functionality may be enabled. The “analog” motion functionality may comprise scrolling, resizing, zooming and/or moving one or more applications. For example, if a user intends to move an application from zone 1 to zone 2 of the section 300, the user may apply a stimulus 302 for a duration that is above the time threshold T, and move the selected application to zone 2, where the distance between zone 1 and zone 2 is above the pixel threshold P. In instances where the motion of the received stimulus 302 is not above a particular pixel threshold P, control passes to step 414. In step 414, the communication device 202 may be operable to display the semi-transparent interaction grid 212 that is superimposed onto the previously displayed content.

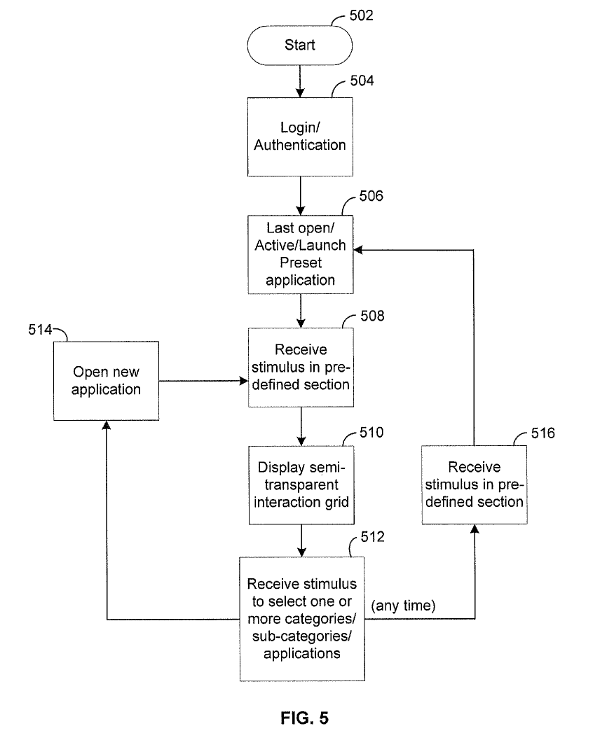

FIG. 5 is a flowchart illustrating exemplary steps for seamlessly integrated navigation of applications, in accordance with an embodiment of the invention. Referring to FIG. 5, exemplary steps may begin at step 502. In step 504, the communication device 202 may be operable to login and/or authenticate a user. In step 506, the communication device 202 may be operable to display a previously enabled application or a user defined application.

In step 508, the communication device 202 may be operable to receive a stimulus, for example, a single touch stimulus 302. In step 510, the communication device 202 may be operable to display the semi-transparent interaction grid 212 that is superimposed onto the previously enabled application or displayed content. In step 512, the communication device 202 may be operable to receive one or more stimuli, for example, 304, 312 and 315 to select one or more categories AA 303, sub-categories AA3 310 and/or applications AA32 316. In instances where the communication device 202 receives another stimulus 325 in the pre-defined section 300 at any time, control passes to step 506. In instances where the communication device 202 does not receive another stimulus 325 in the pre-defined section 300, control passes to step 514. In step 514, the communication device 314 may enable the selected one or more applications, for example, application AA32 316. Control then returns to step 508.

In accordance with an embodiment of the invention, a method and system for seamlessly integrated navigation of applications may comprise one or more processors and/or circuits, for example, a communication device 202 comprising a display 204 enabled to display media content that may be operable to receive one or more stimuli 214 in a pre-defined section 208 of the display 204. The communication device 202 may be operable to display a semi-transparent interaction grid 212 that is superimposed onto the content based on the received one or more stimuli 214. The communication device 202 may be operable to enable one or more applications, for example, application AA32 316 in the displayed semi-transparent interaction grid 212 based on the received one or more stimuli 214. The displayed semi-transparent interaction grid 320 may comprise one or more of categories AA 303 and BB 305, sub-categories CC 307 and DD 309 and/or applications EE 311. Each of the one or more categories 216 and 218, sub-categories AA1 306 and AA3 310, and/or applications AA2 308 that may be organized logically and/or modified based on user preferences. The received one or more stimuli 214 may comprise one or more of a single touch stimulus, a multi-touch stimulus, an infrared stimulus, an ultrasonic stimulus, a keyed input stimulus, and/or a speech-based stimulus.

The communication device 202 may be operable to determine a duration of the received one or more stimuli 214. The communication device 202 may be operable to display the semi-transparent interaction grid 212 that is superimposed onto the previously displayed content, if the duration of the received one or more stimuli 214 is above a particular time threshold T. In accordance with one embodiment of the invention, the particular time threshold T may be adjusted by a user. The communication device 202 may be operable to determine motion of the received one or more stimuli 214. The communication device 202 may be operable to display the semi-transparent interaction grid 212 that is superimposed onto the previously displayed content, if the motion of the received one or more stimuli 214 is above a particular pixel threshold P. In accordance with one embodiment of the invention, the particular pixel threshold P may be adjusted by a user.

The communication device 202 may be operable to exit the displayed semi-transparent interaction grid 212 based on the received one or more stimuli 325. The received one or more stimuli 325 may be outside the pre-defined section 300 of the display 204. For example, in accordance with an embodiment of the invention, if a stimulus 325 is received in section 350, the communication device 202 may be operable to exit the displayed semi-transparent interaction grid. For example, in accordance with another embodiment of the invention, if a stimulus 325 is received in the pre-defined section 300 to enable previously displayed content, the communication device 202 may be operable to exit the displayed semi-transparent interaction grid 212 and enable the previously displayed content.

The communication device 202 may be operable to display an upper level of the semi-transparent interaction grid 320 based on the received one or more stimuli 302. The upper level of the semi-transparent interaction grid 320 may comprise an upper set of categories AA 303 and BB 305, sub-categories CC 307 and DD 309 and/or applications EE 311. The communication device 202 may be operable to display a lower level of the semi-transparent interaction grid 322 based on the received one or more stimuli 302 and 304. The lower level of the semi-transparent interaction grid 322 may comprise a lower set of sub-categories AA1 306 and AA3 310 and/or applications AA2 308. The communication device 202 may be operable to enable one or more applications AA32 316 in the displayed lower level of the semi-transparent interaction grid 324 based on the received one or more stimuli 302, 304, 312 and 315. The communication device 202 may be operable to receive the one or more stimuli 302, 304, 312 and 315 in a pre-defined section 300 of the display 204. The display 204 may be operable to display one or more previously enabled applications, for example, AA32 316. The communication device 202 may be operable to display the semi-transparent interaction grid 212 that is superimposed onto the previously enabled one or more applications AA32 316 based on the received one or more stimuli 214.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for seamlessly integrated navigation of applications.

Accordingly, the present invention may be realized in hardware or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for user interaction, the method comprising
in a communication device comprising a display enabled to display media content:
receiving one or more stimuli in a pre-defined section of said display;
displaying a semi-transparent interaction grid that is superimposed onto said content based on said received one or more stimuli; and
enabling one or more applications in said displayed semi-transparent interaction grid based on said received one or more stimuli.

2. The method according to claim 1, wherein said displayed semi-transparent interaction grid comprises one or more of: categories, sub-categories and/or applications.

3. The method according to claim 2, wherein each of said one or more of: said categories, said sub-categories and/or said applications are organized and/or modified based on user preferences.

4. The method according to claim 1, wherein said received one or more stimuli comprises one or more of: a single touch stimulus, a multi-touch stimulus, an infrared stimulus, an ultrasonic stimulus, a keyed input stimulus, and/or a speech-based stimulus.

5. The method according to claim 1, comprising determining a duration of said received one or more stimuli.

6. The method according to claim 5, comprising displaying said semi-transparent interaction grid that is superimposed onto said content, if said duration of said received one or more stimuli is above a particular time threshold.

7. The method according to claim 6, comprising determining motion of said received one or more stimuli.

8. The method according to claim 7, comprising displaying said semi-transparent interaction grid that is superimposed onto said content, if said motion of said received one or more stimuli is above a particular pixel threshold.

9. The method according to claim 1, comprising exiting said displayed semi-transparent interaction grid based on said received one or more stimuli, wherein said received one or more stimuli is outside said pre-defined section of said display.

10. The method according to claim 1, comprising displaying an upper level of said semi-transparent interaction grid based on said received one or more stimuli, wherein said upper level of said semi-transparent interaction grid comprises an upper set of categories, sub-categories, and/or applications.

11. The method according to claim 10, comprising displaying a lower level of said semi-transparent interaction grid based on said received one or more stimuli, wherein said lower level of said semi-transparent interaction grid comprises a lower set of sub-categories and/or applications.

12. The method according to claim 11, comprising enabling said one or more applications in said displayed lower level of said semi-transparent interaction grid based on said received one or more stimuli.

13. The method according to claim 12, comprising receiving said one or more stimuli in said pre-defined section of said display, wherein said display is operable to display said previously enabled one or more applications.

14. The method according to claim 13, comprising displaying said semi-transparent interaction grid that is superimposed onto said previously enabled one or more applications based on said received one or more stimuli.

15. A system for user interaction, the system comprising:
in a communication device comprising a display enabled to display media content, one or more processors and/or circuits that are operable to:
receive one or more stimuli in a pre-defined section of said display;
display a semi-transparent interaction grid that is superimposed onto said content based on said received one or more stimuli; and
enable one or more applications in said displayed semi-transparent interaction grid based on said received one or more stimuli.

16. The system according to claim 15, wherein said displayed semi-transparent interaction grid comprises one or more of: categories, sub-categories and/or applications.

17. The system according to claim 16, wherein each of said one or more of: said categories, said sub-categories and/or said applications are organized and/or modified based on user preferences.

18. The system according to claim 15, wherein said received one or more stimuli comprises one or more of: a single touch stimulus, a multi-touch stimulus, an infrared stimulus, an ultrasonic stimulus, a keyed input stimulus, and/or a speech-based stimulus.

19. The system according to claim 15, wherein said one or more processors and/or circuits are operable to determine a duration of said received one or more stimuli.

20. The system according to claim 19, wherein said one or more processors and/or circuits are operable to display said semi-transparent interaction grid that is superimposed onto said content, if said duration of said received one or more stimuli is above a particular time threshold.

21. The system according to claim 20, wherein said one or more processors and/or circuits are operable to determine motion of said received one or more stimuli.

22. The system according to claim 21, wherein said one or more processors and/or circuits are operable to display said semi-transparent interaction grid that is superimposed onto said content, if said motion of said received one or more stimuli is above a particular pixel threshold.

23. The system according to claim 15, wherein said one or more processors and/or circuits are operable to exit said displayed semi-transparent interaction grid based on said received one or more stimuli, wherein said received one or more stimuli is outside said pre-defined section of said display.

24. The system according to claim 15, wherein said one or more processors and/or circuits are operable to display an upper level of said semi-transparent interaction grid based on said received one or more stimuli, wherein said upper level of said semi-transparent interaction grid comprises an upper set of categories, sub-categories, and/or applications.

25. The system according to claim 24, wherein said one or more processors and/or circuits are operable to display a lower level of said semi-transparent interaction grid based on said received one or more stimuli, wherein said lower level of said semi-transparent interaction grid comprises a lower set of sub-categories and/or applications.

26. The system according to claim 25, wherein said one or more processors and/or circuits are operable to enable said one or more applications in said displayed lower level of said semi-transparent interaction grid based on said received one or more stimuli.

27. The system according to claim 26, wherein said one or more processors and/or circuits are operable to receive said one or more stimuli in a pre-defined section of said display, wherein said display is operable to display said previously enabled one or more applications.

28. The system according to claim 27, wherein said one or more processors and/or circuits are operable to display said semi-transparent interaction grid that is superimposed onto said previously enabled one or more applications based on said received one or more stimuli.
